(19) United States
(12) Patent Application Publication
(10) Pub. No.: US 2016/0189398 A1
(43) Pub. Date: Jun. 30, 2016

(54) DISPLAY AND METHOD OF DRIVING SAME

(71) Applicant: Samsung Display Co., Ltd., Yongin-City (KR)

(72) Inventors: Hyung June KIM, Anyang-si (KR); Wan-Soon IM, Cheonan-si (KR); Jong Hak HWANG, Yongin-si (KR)

(21) Appl. No.: 14/815,512

(22) Filed: Jul. 31, 2015

(30) Foreign Application Priority Data
Dec. 26, 2014 (KR) 10-2014-0190800

(51) Int. Cl. G06T 7/40; G06T 7/00; G09G 3/36; G06T 3/40

(52) U.S. Cl. CPC G06T 7/408; G06T 3/4038; G06T 7/0085; G09G 3/3607; G09G 3/3696; G06T 2207/10024; G09G 2320/0247

(57) ABSTRACT

A method of driving a display device includes: receiving first frame data and second frame data for successive display on the display device; generating third frame data, the third frame data having values between corresponding values of the first frame data and the second frame data; displaying an image corresponding to the first frame data on the display device; after the displaying an image corresponding to the first frame data, displaying an image corresponding to the third frame data on the display device after the first displaying; and after the displaying an image corresponding to the third frame data, displaying an image corresponding to the second frame data on the display device.

### CROSS-REFERENCE TO RELATED APPLICATION

This application claims priority to, and the benefit of, Korean Patent Application No. 10-2014-0190800 filed in the Korean Intellectual Property Office on Dec. 26, 2014, the entire contents of which are incorporated herein by reference.

### BACKGROUND

(a) Field

This disclosure relates generally to displays. More specifically, the disclosure relates to display devices and associated driving methods.

(b) Description of the Related Art

Currently, liquid crystal displays (LCDs) and organic light emitting diode (OLED) displays are the most widely used flat panel displays. The LCD consists of two sheets of electrode-bearing substrates and a liquid crystal layer interposed therebetween, and displays an image by controlling an amount of transmitted light via signals to the electrodes which realign liquid crystal molecules of the liquid crystal layer. The OLED display instead employs organic light emitting diodes through which an appropriate current can flow to emit light from each pixel so as to display an image.

The LCD and the OLED display both receive an input image signal from an external graphics controller, where the input image signal contains luminance information of each pixel. A data voltage is then applied to each pixel, the magnitude of which corresponds to the particular luminance information for that pixel.

The LCD and the OLED display both include red, green, and blue pixels for color display, and white pixels may be further disposed therein to improve luminance. As such, when these white pixels are disposed together with red, green, and blue pixels, sets of red, green, blue, and white pixels are generally arranged in a 2×2 matrix to represent one dot.

The above information disclosed in this Background section is only for enhancement of understanding of the background of the invention and therefore it may contain information that does not form the prior art that is already known in this country to a person of ordinary skill in the art.

### SUMMARY

When a display has red, green, blue, and white pixels arranged in a 2×2 matrix form, edge flicker may be generated when a moving mosaic pattern is displayed. Such edge flicker deteriorates display quality. Accordingly, embodiments provide display devices with no or reduced edge flicker, as well as methods of driving such devices.

A method of driving a display device according to an exemplary embodiment of the present invention includes: receiving first frame data and second frame data for successive display on the display device; generating third frame data, the third frame data having values between corresponding values of the first frame data and the second frame data; displaying an image corresponding to the first frame data on the display device; after the displaying an image corresponding to the first frame data, displaying an image corresponding to the third frame data on the display device; and after the displaying an image corresponding to the third frame data, displaying an image corresponding to the second frame data on the display device.

After the receiving, the method may include determining whether to generate the third frame data.

The third frame data may comprise gray-level values between corresponding gray-level values of the first frame data and corresponding gray-level values of the second frame data.

A display device according to an exemplary embodiment of the present invention includes: a display panel including a plurality of gate lines, a plurality of data lines, and a plurality of pixels; a gate driver connected to the plurality of gate lines to apply a gate-on voltage; a data driver connected to the plurality of data lines to apply data voltages to the plurality of data lines; and a signal controller programmed to control the gate driver and the data driver according to input data including the first and second frame data for successive display on a display panel. The signal controller may be further programmed to generate third frame data from the first and second frame data, the third frame data having values between corresponding values of the first frame data and the second frame data, and may also be programmed to control the gate driver and the data driver so as to display the first frame data, the third frame data, and the second frame data in order on the display panel.

The display device may further include a memory for temporarily storing the input data.

The signal controller may determine whether to generate the third frame data based on the first frame data and the second frame data.

The third frame data may comprise gray-level values between corresponding gray-level values of the first frame data and corresponding gray-level values of the second frame data.

The plurality of pixels may include red, green, blue, and white colored pixels, and the red, green, blue, and white colored pixels may be arranged in at least one 2×2 matrix to represent one dot.

Relative positions of the red, green, blue, and white colored pixels within one dot may be different from relative positions of the red, green, blue, and white colored pixels within another dot adjacent to the one dot.

The signal controller may comprise the memory.

According to exemplary embodiments of the present invention, an intermediate image, which is an average of the images to be displayed by two adjacent or successive frames, is inserted between the two adjacent or successive frames such that the image is more smoothly changed or transitioned from that of the earlier frame to that of the later frame, thereby reducing the perception of edge flicker.

### BRIEF DESCRIPTION OF THE DRAWINGS

FIG. 1 is a block diagram of a liquid crystal display (LCD) according to an exemplary embodiment of the present invention.

FIG. 2 is an equivalent circuit diagram of one pixel in the LCD according to the exemplary embodiment of the present invention.

FIG. 3 is a layout view of pixels of the LCD according to the exemplary embodiment of the present invention.

FIG. 4 is a flowchart for illustrating a driving method for a display device according to an exemplary embodiment of the present invention.

FIG. 5 schematically illustrates an effect achieved by the driving method according to the exemplary embodiment of the present invention.

### DETAILED DESCRIPTION OF THE EMBODIMENTS

The invention will be described more fully hereinafter with reference to the accompanying drawings, in which exemplary embodiments of the invention are shown. The drawings are not to scale.

As those skilled in the art would realize, the described embodiments may be modified in various different ways, all without departing from the spirit or scope of the present invention.

A display device according to an exemplary embodiment of the present invention and a driving method thereof will now be described in detail with reference to the drawings.

In exemplary embodiments below, a liquid crystal display (LCD) will be described. However, embodiments of the invention are not limited to LCDs, and instead encompass any suitable type of display.

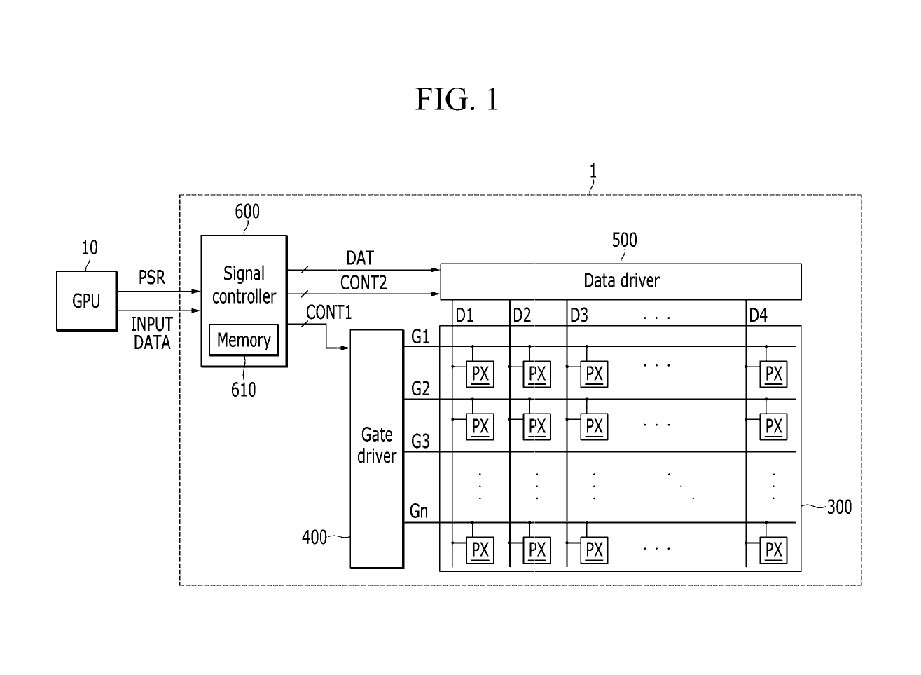

First, an LCD according to an exemplary embodiment of the present invention will be described with reference to FIGS. 1 to 3.

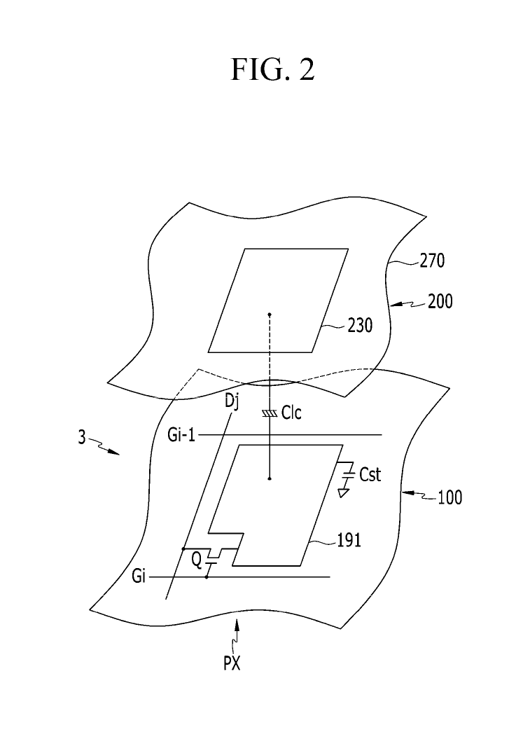

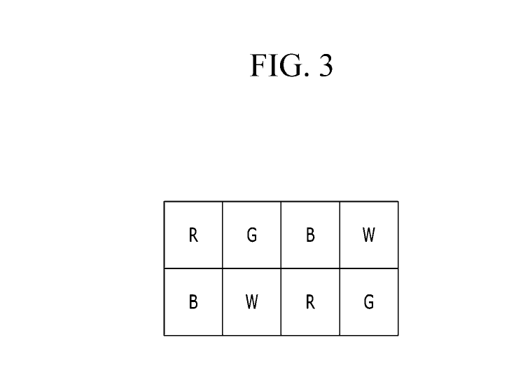

FIG. 1 is a block diagram of an LCD according to an exemplary embodiment of the present invention, FIG. 2 is an equivalent circuit diagram of one pixel in the LCD according to the exemplary embodiment of the present invention, and FIG. 3 is a layout view of pixels of the LCD according to the exemplary embodiment of the present invention.

As shown in FIG. 1, LCD 1 includes a liquid crystal panel 300 for displaying an image, a gate driver 400, a data driver 500, and a signal controller 600.

A graphics processing unit (GPU) 10 disposed outside of the LCD 1 is also illustrated in FIG. 1.

The signal controller 600 includes a memory 610 that receives and temporarily stores input data from the graphics processing unit 10.

The graphics processing unit 10 may provide the image data for an image to be displayed in the LCD 1.

The LCD 1 receives this image data as input data from the graphics processing unit 10, and performs various operations for displaying the corresponding image. In this case, the signal controller 600 receives the input data and stores it in the memory 610, classifies the input data by frame, and compares data of two continuous frames to determine whether an intermediate frame is to be inserted or not. If insertion of an intermediate frame is determined to be appropriate, the signal controller 600 generates an intermediate frame consisting of gray-level values corresponding to averages of gray-level values of the two adjacent (formerly continuous, before the intermediate frame is inserted) frames to insert it inbetween. The condition to determine that the insertion of an intermediate frame is appropriate may be defined by the manufacturer. For example, the condition may be set to be satisfied when gray level of at least one pixel is changed more than 200 between the adjacent frames.

Components of the LCD 1 will now be described in further detail with reference to FIGS. 1 and 2. In particular, the liquid crystal panel 300 includes lower and upper panels 100 and 200 facing each other, and a liquid crystal layer 3 interposed therebetween.

The liquid crystal panel 300 includes a plurality of gate lines G1 to Gn, and a plurality of data lines D1 to Dm. The plurality of gate lines G1 to Gn substantially extend in a horizontal direction, and the plurality of data lines D1 to Dm substantially extend in a vertical direction while being insulated from and crossing the plurality of gate lines G1 to Gn. One of the gate lines G1 to Gn and one of the data lines D1 to Dm are connected to one pixel PX. That is, in the embodiment shown, each pixel PX is connected to one gate line G1 to Gn, and one data line D1 to Dm. These pixels PX are arranged in a matrix form, and each pixel PX may include a thin film transistor Q, a liquid crystal capacitor Clc, and a storage capacitor Cst.

A control terminal of the thin film transistor Q may be connected to one of the gate lines G1 to Gn, an input terminal of the thin film transistor Q may be connected to one of the data lines D1 to Dm, and an output terminal of the thin film transistor Q may be connected to a pixel electrode 191 serving as one terminal of the liquid crystal capacitor Clc. The output terminal of thin film transistor Q may also be connected to one terminal of the storage capacitor Cst.

The other terminal of the liquid crystal capacitor Clc may be connected to a common electrode 270, and the other terminal of the storage capacitor Cst may be configured to have a storage voltage applied thereto.

In this exemplary embodiment of the present invention, the liquid crystal panel 300 may be a plane line switching (PLS) type panel, and in this case, both the pixel electrode 191 and the common electrode 270 are formed to be disposed in the lower panel 100. However, this need not necessarily be the case, and any other type of panel is contemplated.

In some exemplary embodiments, one row of pixels PX may be alternately connected to a pair of gate lines that are disposed thereabove and therebelow. That is, the gate lines G1 to Gn may be alternately connected to the pixels that are disposed thereabove and therebelow, respectively. In other words, successive pixels PX in one pixel row may be connected in alternating manner to the gate line above the row, and the gate line below the row. According to the structure described above, odd-numbered pixels of one pixel row may be connected to one gate line, and even-numbered pixels may be connected to a different gate line. In this case, the data lines D1 to Dm are connected to the pixels that are disposed along one column, respectively.

Referring to FIG. 3, the liquid crystal panel 300 according to this exemplary embodiment of the present invention includes red, green, blue, and white pixels W, R, G, and B, where the red, green, blue, and white pixels W, R, G, and B are disposed in a 2×2 matrix to represent one dot. In addition, adjacent dots may have different arrangements of their red, green, blue, and white pixels R, G, B, and W. Any arrangements are contemplated.

The signal controller 600 appropriately processes input data and control signals thereof that are received from an external source. For example, the signal controller 600 may receive a vertical synchronization signal Vsync, a horizontal synchronization signal Hsync, a main clock signal MCLK, a data enable signal DE, and the like in accordance with an operating condition of the liquid crystal panel 300, and may generate output image data DAT, a gate control signal CONT1, a data control signal CONT2, and a clock signal.

As above, the signal controller 600 determines whether to generate intermediate frames for insertion between two consecutive frames. Whether to insert the intermediate frame or not is determined by checking changes in the shape of the image displayed by the two successive frames, and then determining if the changes in the shape of the image can cause edge flicker. Examples of such changes include movement of a mosaic pattern from one frame to the next.

The gate control signal CONT1 includes a start pulse vertical signal STV for initiating a scan start, and a clock pulse vertical signal CPV referenced to generate a gate-on voltage Von. An output period of the start pulse vertical signal STV corresponds to one frame (or refresh rate). In addition, the gate control signal CONT1 may further include an output enable signal OE for limiting a duration of the gate-on voltage Von.

The data control signal CONT2 includes a start pulse horizontal signal STH indicating a transmission start of the image data DAT for one row of pixels, a load signal TP for applying corresponding data voltages to the data lines D1 to Dm, and the like. The data control signal CONT2 may further include a reverse signal RVS for reversing polarities of the data voltages with respect to a common voltage Vcom.

The signal controller 600 may use the gate control signal CONT1 and the data control signal CONT2 to allow the gate driver 400 and the data driver 500 to display the image corresponding to the input data on the liquid crystal panel 300. In this case, when the intermediate frame is inserted, intermediate frame data is inserted in the image data DAT such that the gate driver 400 and the data driver 500 are controlled to sequentially display the previous frame, the intermediate frame, and the next frame.

The plurality of gate lines G1 to Gn of the liquid crystal panel 300 are connected to the gate driver 400, the gate-on voltage Von is sequentially applied according to the gate control signal CONT1 from the signal controller 600, and the gate-off voltage Voff is applied when the gate-on voltage Von is not applied.

The data lines D1 to Dm of the liquid crystal panel 300 are connected to the data driver 500, and the data driver 500 receives the data control signal CONT2 and the image data DAT from the signal controller 600. Using gray-level voltages generated from a gray-level voltage generator (not shown), the data driver 500 converts the image data DAT into data voltages and transmit these data voltages to the data lines D1 to Dm. The data voltages may be of positive polarity or negative polarity. A data voltage of positive polarity and a data voltage of negative polarity may be alternately applied based on frames, rows, and/or columns according to a voltage inversion scheme, as is known.

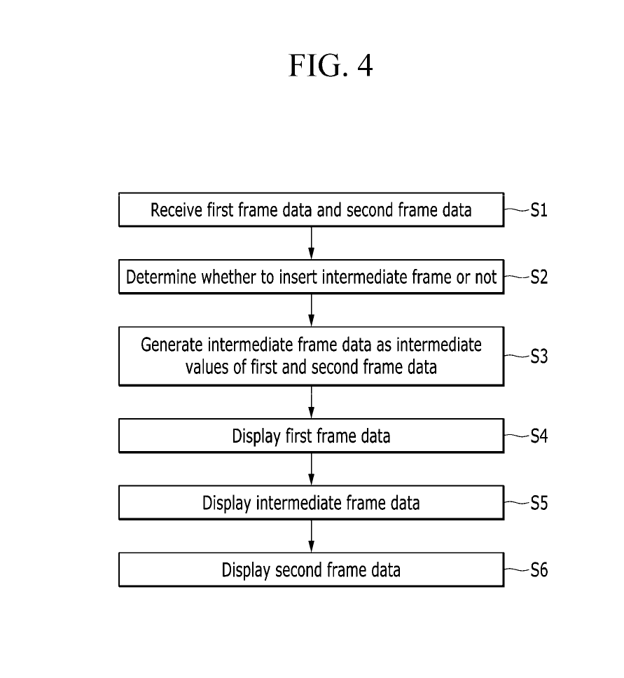

FIG. 4 is a flowchart for illustrating a method of driving a display device according to an exemplary embodiment of the present invention. Referring to FIG. 4, in a display device according to an exemplary embodiment of the present invention, two continuous or sequential frame data, that is, input data including first frame data and second frame data, are received from a graphics processing unit 10 to be temporarily stored in a memory 610 (S1). In this case, the first frame data and the second frame data represent two arbitrary successive frame data from within the input data.

In addition, the input data that is simultaneously stored in the memory 610 may be two or more continuous frame data. That is, the memory 610 may store more than two frames of data. Any amount of data is contemplated.

Next, the first and second frame data are compared to determine whether changes in the shape of an image displayed can cause edge flicker or not, and if they can, insertion of an intermediate frame is determined (S2). The condition for determining the insertion of an intermediate frame may be defined by the manufacturer. For example, the condition may be set to be satisfied when gray level of at least one pixel is changed more than 200 between the first and second frame data.

When insertion of an intermediate frame is determined to be appropriate, intermediate frame data consisting of intermediate gray-level values of the first frame data and the second frame data are generated (S3). That is, an intermediate frame is generated to have gray-level values inbetween the corresponding gray-level values of the first and second frame data. Any intermediate values, determined by any method, are contemplated. For example, each intermediate value may simply be the average of the corresponding values from the first and second frame data. Also, intermediate gray-level values may be generated only for the portions where the flicker is expected, or may be generated for an entire screen. Any other method of determining intermediate values is also contemplated.

Next, image data DAT is generated and is then applied to the data driver 500 such that the first frame data, the intermediate frame data, and the second frame data are sequentially displayed (S4, S5, and S6).

Determining whether the intermediate frame data needs to be generated or not and a process of generating it are shown here as being performed by the signal controller 600, but a separate configuration may be provided for that purpose. That is, the determination of whether intermediate frame data should be generated, as well as its generation, may be carried out by any hardware module, whether inside or outside of signal controller 600.

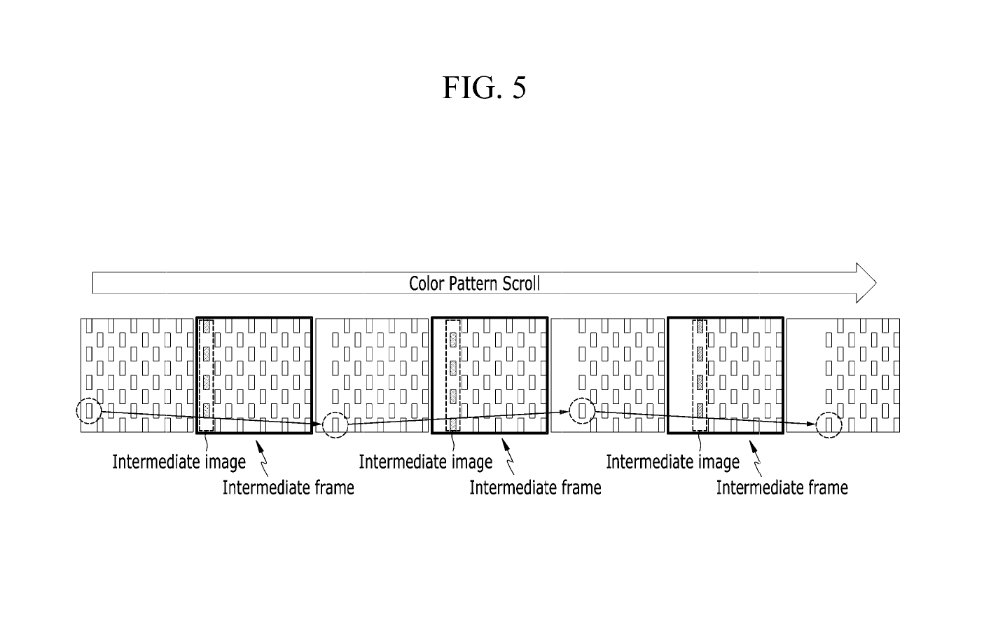

FIG. 5 schematically illustrates an effect achieved by a driving method according to the exemplary embodiment of the present invention. Referring to FIG. 5, intermediate frames are generated with, intermediate gray values that are inbetween the edge gray values of their immediately-preceding and immediately-successive frames. Here, intermediate gray values may be generated only for the portions where the flicker is expected—the remainder of each intermediate image remains the same as its immediately-preceding image, or may be generated for an entire screen. As a result, when successive image frames show a moving mosaic pattern, insertion of an intermediate frame slightly blurs the resulting image, such that the image has a feel of being continuously changed to be perceived as being more smoothly changing. Accordingly, a higher-quality image with no, or reduced, edge flicker can be displayed.

In the above description, an LCD is described as an exemplary embodiment of the present invention, but the present invention can also be applied to various kinds of display devices, such as the OLED display and the like.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Furthermore, different features of the various embodiments, disclosed or otherwise understood, can be mixed and matched in any manner to produce further embodiments within the scope of the invention.

What is claimed is:

1. A method of driving a display device, the method comprising:
receiving first frame data and second frame data for successive display on a display device;
generating third frame data, the third frame data having values between corresponding values of the first frame data and the second frame data;
displaying an image corresponding to the first frame data on the display device;
after the displaying an image corresponding to the first frame data, displaying an image corresponding to the third frame data on the display device; and
after the displaying an image corresponding to the third frame data, displaying an image corresponding to the second frame data on the display device.

2. The method of claim 1, further comprising, after the receiving, determining whether to generate the third frame data.

3. The method of claim 2, wherein the third frame data comprises gray-level values between corresponding gray-level values of the first frame data and corresponding gray-level values of the second frame data.

4. A display device comprising:
a display panel including a plurality of gate lines, a plurality of data lines, and a plurality of pixels;
a gate driver connected to the plurality of gate lines to apply a gate-on voltage;
a data driver connected to the plurality of data lines to apply data voltages to the plurality of data lines; and
a signal controller programmed to control the gate driver and the data driver according to input data including the first and second frame data for successive display on a display panel,
wherein the signal controller is further programmed to generate third frame data from the first and second frame data, the third frame data having values between corresponding values of the first frame data and the second frame data, and wherein the signal controller is also further programmed to control the gate driver and the data driver so as to display the first frame data, the third frame data, and the second frame data in order on the display panel.

5. The display device of claim 4, further comprising a memory for temporarily storing the input data.

6. The display device of claim 5, wherein the signal controller determines whether to generate the third frame data based on the first frame data and the second frame data.

7. The display device of claim 6, wherein the third frame data comprises gray-level values between corresponding gray-level values of the first frame data and corresponding gray-level values of the second frame data.

8. The display device of claim 7, wherein the plurality of pixels includes red, green, blue, and white colored pixels, and the red, green, blue, and white colored pixels are arranged in at least one 2×2 matrix to represent one dot.

9. The display device of claim 8, wherein relative positions of the red, green, blue, and white colored pixels within one dot are different from relative positions of the red, green, blue, and white colored pixels within another dot adjacent to the one dot.

10. The display device of claim 5, wherein the signal controller comprises the memory.
